(19) United States
(12) Patent Application Publication
(10) Pub. No.: US 2017/0217056 A1
(43) Pub. Date: Aug. 3, 2017

(54) Carbon Fiber Information Handling System Housing and Process for Manufacture

(71) Applicant: Dell Products L.P., Round Rock, TX (US)

(72) Inventors: Nicholas D. Abbatiello, Round Rock, TX (US); Chuan Beng Sim, Shanghai (CN)

(73) Assignee: Dell Products L.P., Round Rock, TX (US)

(21) Appl. No.: 15/010,835

(22) Filed: Jan. 29, 2016

(51) Int. Cl. B29C 43/20; G06F 1/16

(52) U.S. Cl. CPC B29C 43/203; G06F 1/1626; G06F 1/1656; G06F 1/1637; B29K 2067/003

(57) ABSTRACT

A portable information handling system housing fabricated from carbon fiber composite material has a PET film applied protective outer surface integrated with an in mold roll process. Heat applied to prepreg material having a polycarbonate resin aids transfer of outer surface protective material and decorative ink from a PET film during a mold insertion operation.

### BACKGROUND OF THE INVENTION

### Field of the Invention

The present invention relates in general to the field of information handling system housings, and more particularly to a carbon fiber information handling system low housing and process for manufacture.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Portable information handling systems continue to shrink in size and increase in capability. Reduced physical size is made practical in part by decreased size and increased capability of processing components used to build portable information handling systems, such as central processing units (CPUs) and graphical processing units (GPUs). Generally, portable information handling system housing size in length and width (X and Y vectors) are driven by the size of the flat panel display integrated in the housing. Tablet information handling systems have a planar housing with a display integrated on one side across most of the width and height, and have processing components disposed underneath the display in a main housing portion. Clamshell and convertible information handling systems have a main housing portion that integrates a keyboard and rotationally couples to a lid housing portion that integrates a display. Rotation of the main and lid housing portions between closed and opened positions lets a user view the display in a raised position while typing inputs at the integrated keyboard, or lets the user expose the display for use in a tablet mode.

Since system width and length are driven by display size, system height (Z vector) often becomes the primary focus for decreasing overall system size and weight. System height is reduced with careful selection of processing components and careful layout of the processing components in the available housing volume so that power and heating constraints are met. Housings typically must have sufficient rigidity to avoid excessive stress placed on processing components or the display during normal use. Torsional stress may be introduced during rotational movement of housing portions relative to each other or during touches at a display of a planar housing. Insufficient housing strength can result in system failures from housing cracks or due to excessive stress placed on electrical connections, such as a motherboard. Excessive housing structure adds to system weight and height, and also tends to increase system cost.

In an effort to provide increased structural soundness with decreased thickness and weight, industry has moved to various alternative materials to build housings, such as carbon fiber composite material. Current manufacturing processes for carbon fiber composite housings used in electronics devices involves a number of steps that tend to have a relatively low roll through put yield. Generally, forming and finishing carbon fiber composite housing portions is a manual process that tends to introduce variations that impact robustness and aesthetics of the components. In a typical manufacture process, forming the correct shape alone can consume 6 to 7 minutes with additional process steps increasing total cycle time to exceed 15 to 20 minutes per part. As a result, carbon fiber material typically is limited to use in low volume and high cost products.

### SUMMARY OF THE INVENTION

Therefore, a need has arisen for a system and method which provides carbon fiber information handling system housing manufacture in volume.

In accordance with the present invention, a system and method are provided which substantially reduce the disadvantages and problems associated with previous methods and systems for carbon fiber information handling system housing manufacture. A carbon fiber composite prepreg material has an external decorative and protective coat applied with a polyethylene terephthalate (PET) film applied in a mold process that provides a completed carbon fiber housing with minimal post mold treatment.

More specifically, a carbon fiber prepreg material is fabricated to a mold shape, such as with CNC machining, and inserted into a mold, such as in a mold cavity or on a mold core. The carbon fiber prepreg material is preheated and then placed in a heated mold. Preheating the prepreg material before inserting into the mold reduces cycle time for transition to a carbon fiber composite. While disposed in the mold and before the mold is closed, the carbon fiber prepreg has a PET film applied at the outer surface. The mold closes to apply heat to the prepreg material for transition into a carbon fiber composite. During application of the heat, adhesive, ink and a protective coating layer transfer from the PET film by heat to integrate with the carbon fiber prepreg and composite so that the completed housing piece has a protective outer surface at the outer surface of the housing, including decorative ink designs if desired. For example, the PET film transfers a protective ultraviolet (UV) hard coat or a soft touch polyurethane (PU) coating layer. The outer protective surface deposited by the in mold PET film integrates with resin of the prepreg material, such as with compatible thermoplastic or polycarbonate materials included in the resin and outer coating that react with each other in a compatible manner. Combining forming, heating, insert molding and decoration into a single in mold process step improves manufacture efficiency and provides improved variance control.

The present invention provides a number of important technical advantages. One example of an important technical advantage is that volume production of finished carbon fiber composite housings is efficiently performed to provide high quality and cost effective electronic enclosure housings. In mold PET film treatment efficiently integrates a protective outer coat with carbon fiber prepreg material during heat treatment to transition the prepreg material into a carbon fiber composite material while using heat treatment as a catalyst for transfer the housing outer treatment that adds desired texture, color and patterns so that post process paint treatments are unnecessary. A single mold forming process step with exterior film treatment outputs a finished part in manner adapted to automated production. Limiting manual steps improves throughput, reduces component variance and allows high volume production of light weight yet robust housings for information handling systems. In one example implementation, rolled throughput yield of housings improved from 53% to 84% by applying outer surface treatment with PET film compared to conventional post mold treatments.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a blown up view of a portable information handling system having a carbon fiber composite housing treated with a PET film;

FIG. 2 depicts a manufacture process for in roll molding of the carbon fiber composite housing; and

FIG. 3 depicts a flow diagram of a process for fabrication of a carbon fiber electronic enclosure housing having an outer surface treated with material transferred from a PET film.

### DETAILED DESCRIPTION

Integration of an outer surface treatment from a PET film into a carbon fiber prepreg mold heat process efficiently treats an information handling system carbon fiber composite housing exterior. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

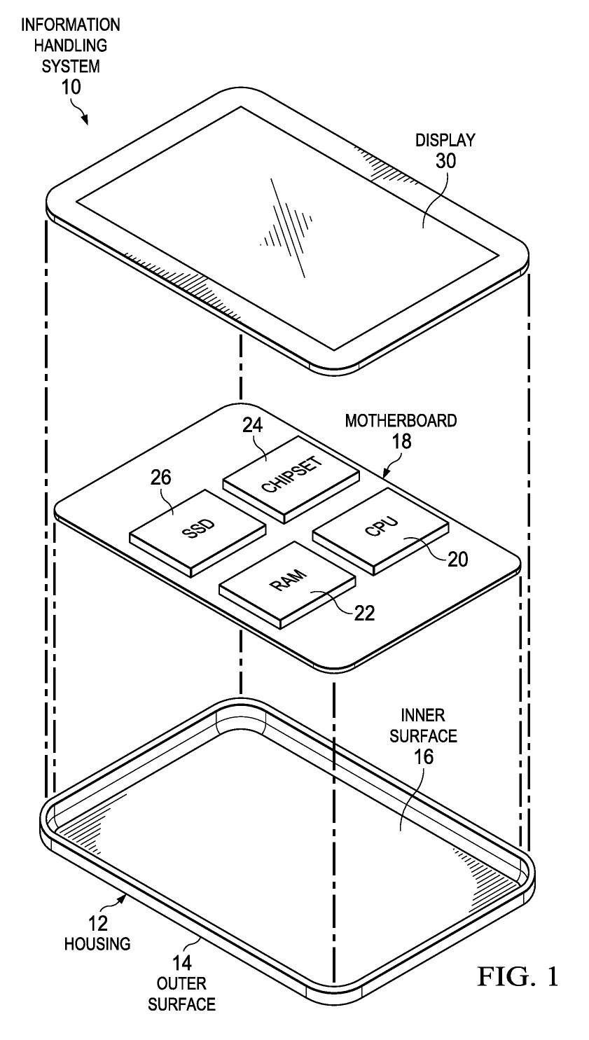

Referring now to FIG. 1, a blown up view depicts a portable information handling system 10 having a carbon fiber composite housing 12 treated with an outer surface material using a PET film. Information handling system 10 processes information with processing components disposed on a motherboard 18. For example, a central processing unit (CPU) 20 executes instructions stored in random access memory (RAM) 22 to generate information for presentation to an end user, such as by running an application and operating system from a persistent memory, such as a solid state drive (SSD) 26. A chipset 24 coordinates the interaction of processing components and includes graphics processing resources that generate pixel data for presenting the information has visual images at a display 30. In the example embodiment, display 30 couples over motherboard 18 to enclose the processing components at the inner surface 16 of housing 12 in a tablet configuration. An outer surface 14 of housing 12 protects the contents within inner surface 16. For example, housing 12 has a carbon fiber composite construction with a decorative and protective outer surface 14 that improves housing material durability and aesthetics. For example, the outer surface transfers from PET film to apply a UV hard coat or soft touch coating layer that includes decorative ink. In alternative embodiments, information handling system 10 may be manufactured from multiple housing components having carbon fiber material with outer surface treatment as described herein. For example, information handling system 10 may have a clamshell or convertible configuration with rotationally coupled main and lid housing portions each made of carbon fiber composite material. In other alternative embodiments, alternative types of electronic devices may use one or more of the housings 12 as described herein for an electronic enclosure.

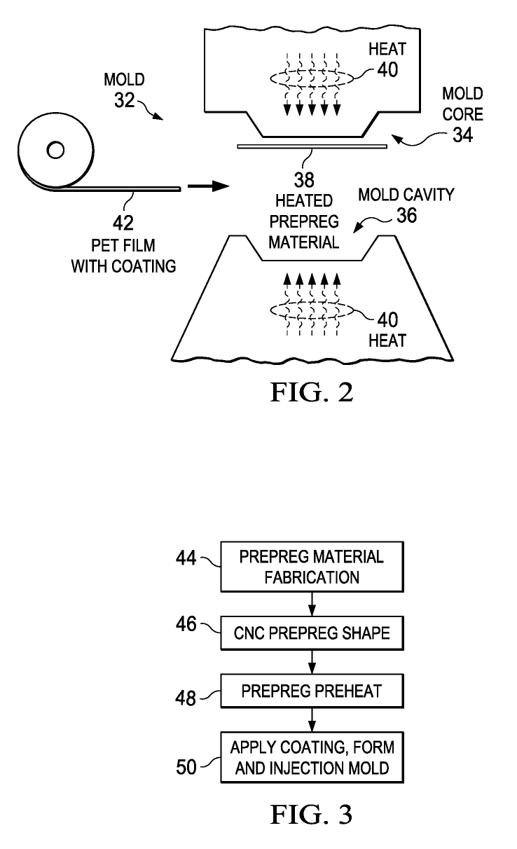

Referring now to FIG. 2, a manufacture process is depicted for in roll molding of the carbon fiber composite housing. A mold 32 has a mold core 34 and mold cavity 36 that close together to shape and harden prepreg material 38 into a desired housing shape of carbon fiber composite material. Prepreg material 38 is a carbon fiber material mixed with a polycarbonate or similar thermoplastic resin that together provides a consistency that maintains a shape, such as shape formed to match the mold cavity and core. For example, computer numerical control (CNC) machining is performed on the prepreg material to establish the mold shape and then the prepreg material 38 has heat applied before insertion into a mold. Preheating of the prepreg material before insertion in the mold reduces cycle time. At insertion into mold 32, heat 40 is applied by the mold in an operation that transitions prepreg material 38 to a hardened carbon fiber housing.

Once prepreg material 38 is preheated and inserted into the mold, a PET (or similar) film 42 is applied to the outer surface of prepreg material 38 and mold 32 is closed to form a housing. In the example embodiment, an in mold roll of PET film 42 is performed by feeding PET film 42 roll to roll in between cavity 36 and core 34 of mold 32. PET film 42 is coated with an adhesive, ink and protective outer surface material that is compatible with the resin of the prepreg material. PET film 42 transfers the coating to the prepreg material for integration with the carbon fiber composite as the carbon fiber resin hardens. Heat 40 applied to transition prepreg 38 into carbon fiber composite is also used as the catalyst to get the ink/hardcoat to transfer off the roll foil and onto the housing part. The PET film material is compatible with the prepreg polycarbonate or similar resin so that the ink and outer coating material integrate with the carbon fiber composite in the hardening process to provide a protective and decorative outer surface. In the example embodiment, one side of the housing has the protective outer surface material covering. In alternative embodiments, both sides may have the protective outer surface material coating film applied. The carbon fiber composite may have a woven or unidirectional pattern and may include additional materials, such as glass fiber or aramids. In alternative embodiments, a glass fiber or aramid prepreg may be used in the place of a carbon fiber prepreg.

In some instances, housings have more complex geometries that make smooth application of a film difficult. As an alternative to in mold roll application of PET film 42, an in mold forming process is used to adapt the PET application to more complex geometries. PET film 42 is thermoformed to the mold shape, trimmed to match the mold shape, and then inserted into the mold, which is heated and closed to perform the PET outer surface film material transfer. Preforming the PET film to the mold shape provides smoothed application of the PET film to achieve deep draw and complicated geometries. In some embodiments, an ultraviolet cure is provided to the outer surface material after transfer of the material from the PET film to aid in hardening.

Referring now to FIG. 3, a flow diagram of a process for fabrication of a carbon fiber electronic enclosure housing having an outer surface treated with material transferred from a PET film. The process starts at step 44 with prepreg fabrication, such as the mixing of a polycarbonate resin with a carbon fiber material. At step 46, CNC of the prepreg is performed to establish the mold shape. At step 48, the pregreg material is preheated to reduce mold cycle time. At step 50, a coating, form and injection mold is applied to the prepreg material in the mold, the mold is closed and heat is applied to transition the prepreg to carbon fiber composite and to integrate the PET film outer surface material and decorative ink of the film into the housing. Once the mold opens, the housing part is released without need for secondary operations.

Although the present invention has been described in detail, it should be understood that various changes, substitutions and alterations can be made hereto without departing from the spirit and scope of the invention as defined by the appended claims.

What is claimed is:

1. A method of manufacture of a portable information handling system housing, the method comprising:
forming a carbon fiber prepreg material to a mold shape;
preheating the carbon fiber prepreg material;
inserting the preheated prepreg material into a mold;
disposing a film over the carbon fiber prepreg material;
closing a core of the mold over a cavity of the mold to capture the prepreg material and film; and
forming a housing in the mold, the film transferring and outer surface treatment during the forming to integrate with the prepreg material transition to a carbon fiber composite material.

2. The method of claim 1 wherein forming the carbon fiber prepreg material to a mold shape further comprises computer numerical control machining of the carbon fiber prepreg material to the mold shape.

3. The method of claim 1 wherein disposing the film further comprises in mold roll of a PET film between the cavity and core to cover an outer surface of the housing.

4. The method of claim 1 wherein disposing the film further comprises:
forming a PET film to the mold shape;
trimming the PET film mold shape to fit in the cavity over the prepreg material; and
inserting the PET film in the cavity over the prepreg material.

5. The method of claim 4 wherein forming the PET film to the mold shape further comprises thermoforming the PET film to the mold shape.

6. The method of claim 5 wherein forming the PET film to the mold shape further comprises trimming the formed PET film to fit in the mold cavity.

7. The portable information handling system of claim 1 wherein the prepreg material comprises a composite polycarbonate resin.

8. The portable information handling system of claim 7 further comprising treating the housing with ultraviolet light cure after the forming.

9. A portable information handling system comprising:
processing components cooperating to process information;
a display interfaced with the processing components and operable to present the information as visual images; and
a housing shaped to contain the processing components, the housing fabricated by:
forming a carbon fiber prepreg material to a mold shape;
preheating the carbon fiber prepreg material in the mold;
disposing a PET film over the carbon fiber prepreg material;
closing a core of the mold over a cavity of the mold to capture the prepreg material and PET film; and
forming a housing in the mold, the PET film transferring an outer surface material during the forming to integrate with the prepreg material transition to a carbon fiber composite material.

10. The portable information handling system of claim 9 wherein:
the housing has a planar shape sized to accept the display in a tablet configuration; and
the processing components are disposed in the housing and covered by the display.

11. The portable information handling system claim 9 wherein disposing the PET film further comprises in mold roll of the PET film between the cavity and core to cover an outer surface of the housing.

12. The portable information handling system of claim 9 wherein disposing the PET film further comprises:
forming the PET film to the mold shape;
trimming the PET film mold shape to fit in the cavity over the prepreg material; and
inserting the PET film in the cavity over the prepreg material.

13. The portable information handling system of claim 9 wherein the carbon fiber comprises a unidirectional pattern.

14. The portable information handling system of claim 9 wherein the carbon fiber comprises a woven pattern.

15. A method for electronic enclosure fabrication, the method comprising:
placing a carbon fiber prepreg material in a mold;
preheating the carbon fiber prepreg material in the mold;
applying a film to one side of the carbon fiber prepreg material, the film having an outer surface protective material; and
closing the mold to transition the carbon fiber prepreg into a carbon fiber composite housing with heat treatment, the heat treatment transferring the outer surface protective material from the film to integrate with the carbon fiber composite housing.

16. The method of claim 15 wherein applying the film further comprises in mold roll of the film between a cavity and a core of the mold to cover an outer surface of the prepreg material.

17. The method of claim 15 wherein applying the film further comprises:
forming the film to the mold shape;
trimming the film mold shape to fit in a cavity of the mold over the prepreg material; and
inserting the film in the cavity over the prepreg material.

18. The method of claim 17 wherein forming the film to the mold shape further comprises thermoforming the film to the mold shape.

19. The method of claim 16 wherein the prepreg material comprises a polycarbonate resin.

20. The method of claim 19 wherein film comprises a decorative ink design.
